(19) United States
(12) Patent Application Publication
(10) Pub. No.: US 2014/0329168 A1
(43) Pub. Date: Nov. 6, 2014

(54) HYBRID BIPOLAR PLATE ASSEMBLY FOR FUEL CELLS

(71) Applicants: Daimler AG, Stuttgart (DE); Ford Motor Company, Dearborn, MI (US)

(72) Inventors: Wayne Dang, Burnaby (CA); Robert Wingrove, Coquitlam (CA); Robert Alois Esterer, North Vancouver (CA); Robert Henry Artibise, Vancouver (CA)

(73) Assignees: Daimler AG, Stuttgart (DE); Ford Motor Company, Dearborn, MI (US)

(21) Appl. No.: 14/261,685

(22) Filed: Apr. 25, 2014

Related U.S. Application Data
(60) Provisional application No. 61/819,600, filed on May 5, 2013.

(51) Int. Cl. H01M 8/02

(52) U.S. Cl. CPC H01M 8/0258; H01M 2008/1095
USPC 429/492; 429/514; 429/535

(57) ABSTRACT

Hybrid bipolar plate assemblies comprising a metal subassembly and a carbonaceous flow field insert can be used to provide for greater current densities from smaller volume fuel cell stacks. In particular, such hybrid bipolar plate assemblies allow for the combination of preferred oxidant channel structures, which can be formed in carbonaceous oxidant flow field inserts, with preferred smaller bipolar plate assembly thicknesses, which are possible with the use of metal plate subassemblies.

### BACKGROUND

1. Field of the Invention

This invention relates to bipolar plate assemblies for fuel cells and particularly for solid polymer electrolyte fuel cells intended for applications requiring high power density.

2. Description of the Related Art

Fuel cells such as solid polymer electrolyte or proton exchange membrane fuel cells electrochemically convert reactants, namely fuel (such as hydrogen) and oxidant (such as oxygen or air), to generate electric power. Solid polymer electrolyte fuel cells generally employ a proton conducting, solid polymer membrane electrolyte between cathode and anode electrodes. A structure comprising a solid polymer membrane electrolyte sandwiched between these two electrodes is known as a membrane electrode assembly (MEA). In a typical fuel cell, flow field plates comprising numerous fluid distribution channels for the reactants are provided on either side of a MEA to distribute fuel and oxidant to the respective electrodes and to remove by-products of the electrochemical reactions taking place within the fuel cell. Water is the primary by-product in a cell operating on hydrogen and air reactants. Because the output voltage of a single cell is of order of 1V, a plurality of cells is usually stacked together in series for commercial applications in order to provide a higher output voltage. Fuel cell stacks can be further connected in arrays of interconnected stacks in series and/or parallel for use in automotive applications and the like.

Along with water, heat is a significant by-product from the electrochemical reactions taking place within the fuel cell. Means for cooling a fuel cell stack is thus generally required. Stacks designed to achieve high power density (e.g. automotive stacks) typically circulate liquid coolant throughout the stack in order to remove heat quickly and efficiently. To accomplish this, coolant flow fields comprising numerous coolant channels are also typically incorporated in the flow field plates of the cells in the stacks. The coolant flow fields may be formed on the electrochemically inactive surfaces of the flow field plates and thus can distribute coolant evenly throughout the cells while keeping the coolant reliably separated from the reactants.

Bipolar plate assemblies comprising an anode flow field plate and a cathode flow field plate which have been bonded and appropriately sealed together so as to form a sealed coolant flow field between the plates are thus commonly employed in the art. Various transition channels, ports, ducts, and other features involving all three operating fluids (i.e. fuel, oxidant, and coolant) may also appear on the inactive side and other inactive areas of these plates. The operating fluids may be provided under significant pressure and thus all the features in the plates have to be sealed appropriately to prevent leaks between the fluids and to the external environment. A further requirement for bipolar plate assemblies is that there is a satisfactory electrical connection between the two plates. This is because the substantial current generated by the fuel cell stack must pass between the two plates.

The plates making up the assembly may optionally be metallic and are typically produced by stamping the desired features into sheets of appropriate metal materials (e.g. certain corrosion resistant stainless steels). Two or more stamped sheets are then typically welded together so as to appropriately seal all the fluid passages from each other and from the external environment. Additional welds may be provided to enhance the ability of the assembly to carry electrical current, particularly opposite the active areas of the plates. Metallic plates may however be bonded and sealed together using adhesives. Corrosion resistant coatings are also often applied before or after assembly.

The plates making up the bipolar plate assembly may also optionally be carbonaceous and are typically produced by molding features into plates made of appropriate moldable carbonaceous materials (e.g. polymer impregnated expanded graphite). Such plates are frequently sealed together using elastomeric contact seals with the entire stack being held under a compression load applied by some suitable mechanical means. More recently, bipolar plate assemblies are being prepared using adhesives that are capable of withstanding the challenging fuel cell environment.

Hybrid bipolar plate assemblies have also been contemplated in the art in which the components making up the assemblies comprise different materials. For instance, US20050244700 discloses a hybrid bipolar plate assembly which comprises a metallic anode plate, a polymeric composite cathode plate, and a metal layer positioned between the metallic anode plate and the composite cathode plate. The metallic anode and composite cathode plates can further comprise an adhesive sealant applied around the outer perimeter to prevent leaking of coolant. The assembly can be incorporated into a device comprising a fuel cell. Further, the device can define structure defining a vehicle powered by the fuel cell. Other variants which are apparent to those skilled in the art include hybrid bipolar plate assemblies which comprise a metallic anode plate and a polymeric carbonaceous composite cathode plate which have been glued or bonded together in other conventional manners.

In another example for an air cooled fuel cell, WO2009/142994 discloses a composite bipolar separator plate which is used in place of a thicker bipolar plate made from a single piece of material. The composite separator plate comprises a base plate and a corrugated plate. The base plate has an anode flow field on one major surface and the corrugated plate is adjacent the other major surface of the base plate. The major surface of the corrugated plate that is opposite the base plate serves as a cathode flow field. The adjacent major surfaces of the corrugated plate and the base plate together define air cooling channels that would not generally be present if the plate were made in a single piece. This composite construction provides greater air cooling capacity for a given thickness of bipolar plate.

In order to obtain the greatest power density possible, developers of fuel cells strive to make the fuel cell stacks smaller, and particularly by reducing the thickness of the numerous bipolar plates in the stack. However, developers are now reaching limitations associated with the various materials involved. For instance, very thin (e.g. 0.9 mm thick) bipolar plate assemblies can be made of cold formed, 0.1 mm thick stainless steel sheets. However due to forming limits, features such as the radii of the landings separating the oxidant channels and the draft angles of the oxidant channel walls cannot be made as small as those possible in carbonaceous materials. Further, the coolant channel size (and hence hydraulic diameter) also cannot be made as small as that possible in carbonaceous materials.

On the other hand, bipolar plate assemblies made with carbonaceous materials cannot be made as thin overall as those made with metallic plates. For instance, due to mechanical properties of the materials, a desired depth for flow purposes in the transition regions cannot be achieved unless thicker carbonaceous plates are employed. (Otherwise cracks occur in the plates under typical fuel cell stack loads.)

There remains a need for greater improvement in power density from fuel cell stacks, and particularly for automotive applications. This invention fulfills these needs and provides further related advantages.

### SUMMARY

The present invention provides bipolar plate assemblies which combine certain advantages of metal plate designs (e.g. deep transition regions) with those of carbonaceous plate designs (e.g. small flow field channel features) to achieve a desirably thin overall assembly capable of achieving high current densities. With smaller landing radii and draft angles in the oxidant flow field channels, improved cell performance can be obtained. And with smaller coolant flow field channels, a sufficient coolant pressure drop can be obtained in the coolant flow field to achieve good coolant flow sharing. The design also simplifies the welding operation between metal plates since there is no channel-to-channel alignment requirement.

Specifically, a hybrid bipolar plate assembly for a fuel cell is provided comprising a metal subassembly comprising a metal anode plate bonded to a metal cathode plate in which the metal subassembly comprises coolant channels between the anode and cathode plates, one of the plates comprises a flow field formed in the metal, and the other plate comprises a recess for a flow field insert. In addition, the assembly comprises a carbonaceous flow field insert located in the recess in which the insert comprises reactant flow field channels separated by landings.

The metal anode plate can be bonded to the metal cathode plate in a variety of conventional manners, including gluing and brazing. In particular though, the two metal plates can be welded together.

Although the carbonaceous flow field insert can be considered for either the cathode or anode plate, the former is selected in order to obtain small flow field features in the oxidant flow field channels. In this embodiment, the anode plate thus comprises a fuel flow field formed in the metal, the cathode plate comprises a recess for an oxidant flow field insert, and the carbonaceous flow field insert is a carbonaceous oxidant flow field insert. In one embodiment, the carbonaceous oxidant flow field insert comprises a plurality of parallel straight oxidant flow field channels separated by landings.

The carbonaceous oxidant flow field insert can be a carbon or a carbon/plastic composite and can be made by molding techniques. Alternatively, such plates can be produced by appropriate extrusion or machining methods. The metal subassembly can be made from a variety of appropriately coated, stainless steel alloys including coated 1.4404, 316L, and 1.4435 alloys.

In such assemblies, many desirable dimensions for the components and features therein can simultaneously be obtained. It is possible to obtain hydraulic diameters for the coolant channels of less than or about 0.5 mm. Further, radii of the landings in the oxidant flow field insert can be obtained that are less than or about 0.1 mm. Draft angles of the oxidant flow field channels can be obtained that are less than or about 10 degrees. The width of the oxidant flow field channels can be less than about 0.9 mm. The hydraulic diameter of the oxidant channels can be less than or about 0.4 mm. And the depth of the oxidant flow field channels can be less than or about 0.4 mm. And advantageously, the carbonaceous oxidant flow field insert can be less than about 0.5 mm thick, and the resulting hybrid bipolar plate assembly less than or about 1.1 mm thick.

With these dimensions and capabilities, such hybrid bipolar plate assemblies are suitable for use in solid polymer electrolyte fuel cells, and particularly in stacks of such fuel cells for high power density applications (e.g. automotive).

The aforementioned hybrid bipolar plate assemblies can be manufactured by forming a metal anode plate and a metal cathode plate such that a flow field is formed in the metal of one of the plates and a recess for a flow field insert is formed in the other plate. Then, the metal anode plate and the metal cathode plate are bonded together to create a metal subassembly comprising coolant channels between the anode and cathode plates. A carbonaceous flow field insert is formed such that reactant flow field channels separated by landings are formed in the insert, and is then located into the recess. In creating the metal subassembly, the hydraulic diameter of the coolant channels is sufficiently small to provide for superior coolant flow sharing. And in forming the carbonaceous flow field insert, the radius of the landings and the draft angle of the reactant flow field channels are sufficiently small to provide for superior reactant diffusion under the landings, and hence for high current density operation in a fuel cell.

These and other aspects of the invention are evident upon reference to the attached Figures and following detailed description.

### BRIEF DESCRIPTION OF THE DRAWINGS

FIG. 1 shows an isometric exploded view of a bipolar plate assembly from a solid polymer fuel cell that is illustrative of the prior art. In FIG. 1, the oxidant side of the cathode flow field plate and the coolant side of the anode flow field plate are visible.

FIGS. 2a and 2b show schematic cross sectional views of bipolar plate assemblies from the prior art which have been made of metal plates and made of carbon plates respectively.

FIGS. 3a and 3b show schematic cross sectional views of an exploded and an assembled hybrid bipolar plate assembly respectively in which the assembly comprises a metal anode and cathode plate subassembly and a carbon oxidant flow field insert.

FIG. 4 shows an isometric exploded view of a hybrid bipolar plate assembly.

FIGS. 5a and 5b show cross sectional profiles of an oxidant channel in actual typical oxidant flow field plates made from metal and carbon/plastic composite respectively. These illustrate the shapes and limitations for the features which can be formed in those materials.

FIG. 5c illustrates the definition of landing radius and draft angle along with other parameters involved in their determination.

### DETAILED DESCRIPTION

In this specification, words such as “a” and “comprises” are to be construed in an open-ended sense and are to be considered as meaning at least one but not limited to just one.

Herein, in a quantitative context, the term “about” should be construed as being in the range up to plus 10% and down to minus 10%.

“Carbonaceous” has its plain meaning, namely meaning consisting of or containing carbon. For instance, carbonaceous refers to objects that consist essentially only of carbon or that simply contain carbon such as carbon composites (e.g. a composite of carbon and plastic).

In this specification, “draft angle” qualitatively refers to the angle that a given channel wall makes with respect to the normal to the adjacent landing in a flow field. However, because channel walls are not straight lines and have varying shapes depending on the materials and forming methods used, it is determined empirically here for quantitative purposes. “Landing radius” qualitatively refers to the radius of the rounded corner between the channel wall and landing. In a like manner to “draft angle”, “landing radius” is also determined empirically. Herein, the specific procedures for determining these values relies on use of a Carl Zeiss Surfcom 1900 SDZ Contour and Surface measurement machine. These specific procedures are described in detail in the Examples below.

Bipolar plate assemblies of the invention combine the thinness of metal plate designs with certain smaller flow field channel features of carbonaceous plate designs, thus enabling greater power densities than conventional fuel cell stacks. In addition, coolant channels in the assemblies between the anode and cathode plates can also be made small enough to achieve good coolant flow sharing.

As demonstrated in the Examples below, some subtle differences in the features of the oxidant flow field channels in solid polymer electrolyte fuel cells can significantly affect cell performance and power output. In particular, surprisingly larger landing radii and draft angles of the channel walls can lead to a reduction in performance, likely from mass transfer related issues. For mechanical reasons, it is possible to practically manufacture smaller landing radii and draft angles in carbonaceous plates than in metallic plates made from a sheet forming process. Thus, carbonaceous materials are preferred over metallic plates with regards to obtaining such features.

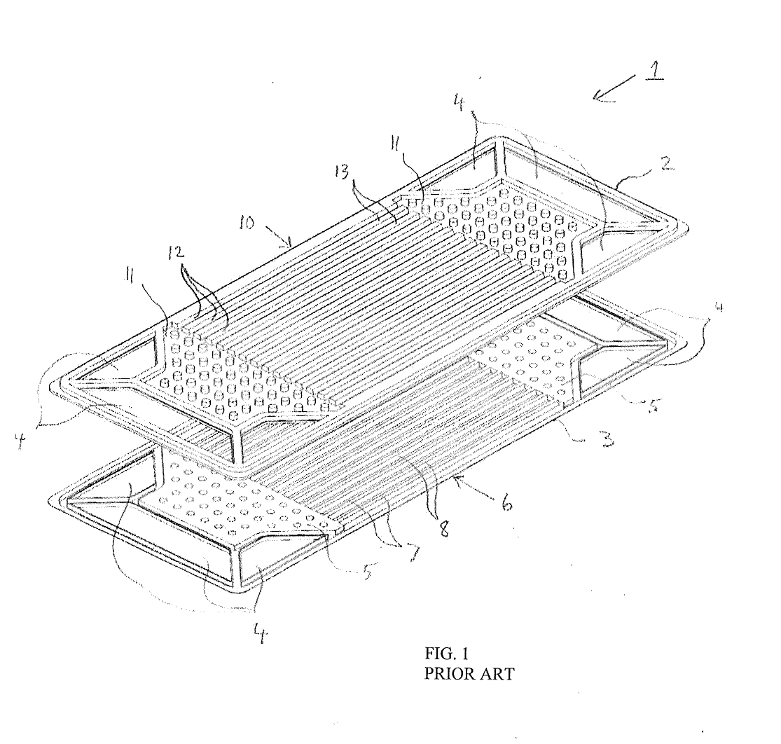

A fuel cell stack design suitable for automotive purposes typically comprises a series stack of generally rectangular, planar solid polymer electrolyte fuel cells. Bipolar plate assemblies with oxidant and fuel flow fields on opposite sides and with coolant flow fields formed within are typically employed in such stacks. FIG. 1 shows an isometric exploded view of a bipolar plate assembly from a solid polymer fuel cell that is illustrative of the prior art. Here, exploded bipolar plate assembly 1 comprises cathode flow field plate 2 and anode flow field plate 3. In this figure, the oxidant side of cathode flow field plate 2 and the coolant side of anode flow field plate 3 are visible.

Numerous features may be present on such flow field plates. For instance in FIG. 1, anode flow field plate 3 comprises a fuel flow field on the opposite side (not shown), inlet and outlet manifold openings 4 for the fuel, oxidant, and coolant fluids, inlet and outlet fuel transition regions on the opposite side (not shown), inlet and outlet coolant transition regions 5, and coolant flow field 6. Coolant flow field 6 comprises a plurality of parallel, straight coolant flow field channels 7 separated by landings 8. In a like manner, cathode flow field plate 2 comprises oxidant flow field 10, a coolant flow field on the opposite side (not shown), inlet and outlet manifold openings 4 for the fuel, oxidant, and coolant fluids, inlet and outlet oxidant transition regions 11, and inlet and outlet coolant transition regions on the opposite side (not shown). Oxidant flow field 10 also comprises a plurality of parallel, straight oxidant flow field channels 12 separated by landings 13.

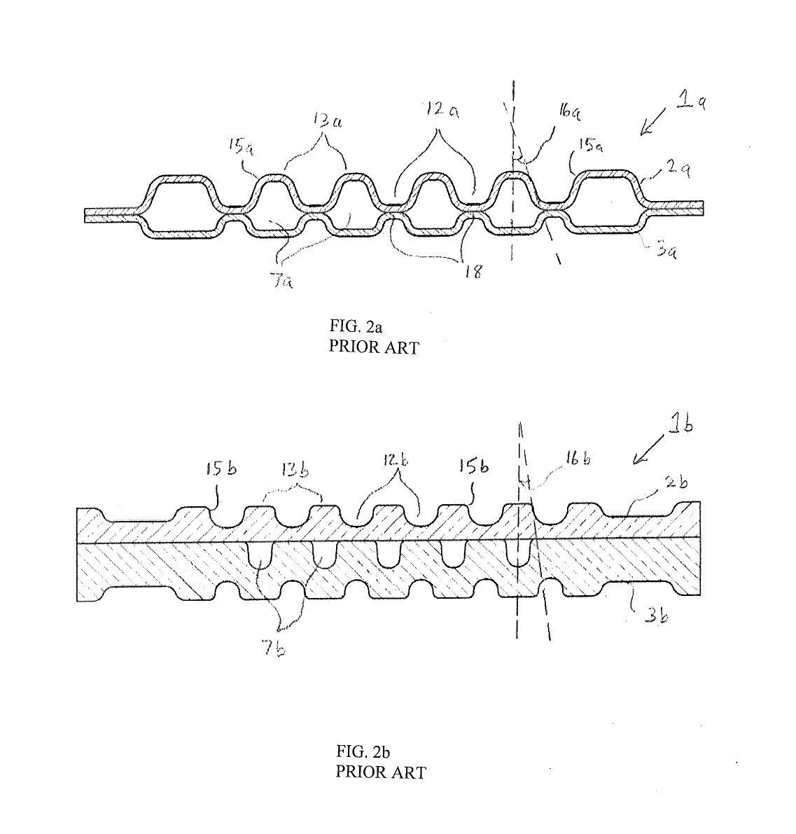

FIGS. 2a and 2b show schematic cross sectional views of bipolar plate assemblies from the prior art which have been made either entirely of metal plates and made entirely of carbon plates respectively. (The sections are taken perpendicular to and through the flow fields in the assemblies.) While the views in FIGS. 2a and 2b are not to scale, they qualitatively depict some of the dimensional differences between the two. For instance, metal cathode and anode flow field plates 2a, 3a are generally thinner than carbonaceous cathode and anode flow field plates 2b, 3b. And overall, bipolar plate assembly 1a made with metal plates is thinner than bipolar plate assembly 1b made with carbonaceous plates. And while flow field channels of similar hydraulic diameter can be formed in each material, the radii at the landings and draft angle of the channels formed cannot readily be made as small in the metal cathode and anode flow field plates 2a, 3a as can be made in the carbonaceous cathode and anode flow field plates 2b, 3b. For instance, landing radii 15a at landings 13a separating oxidant flow field channels 12a in the metal plates are larger than landing radii 15b at landings 13b separating oxidant flow field channels 12b in the carbonaceous plates. Further, draft angles 16a for oxidant flow field channels 12a in the metal plates are larger than draft angles 16b for oxidant flow field channels 12b in the carbonaceous plates. The larger landing radii and draft angles associated with metal plates necessitate a greater width for the oxidant flow field channels, which can be undesirable for performance reasons. Further still, while cathode flow field plate 2a can be bonded to anode flow field plate 3a in a variety of manners, welding is commonly preferred. Typically welds are made at interfaces 18 where oxidant flow field channels 12a on cathode flow field plate 2a align with and contact the fuel flow field channels on adjacent anode flow field plate 3a. Welding requirements necessitate a flat bottom and hence minimum width for the oxidant flow field channels which can be greater than desired for performance reasons. It can also be challenging to maintain the alignment and straightness required for this type of welding.

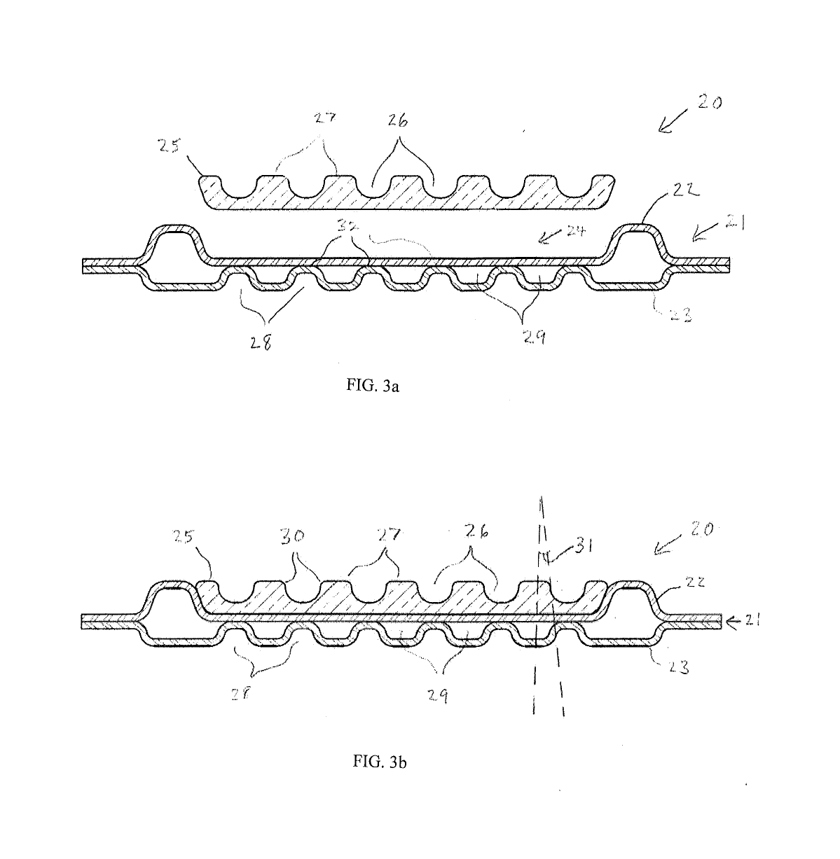

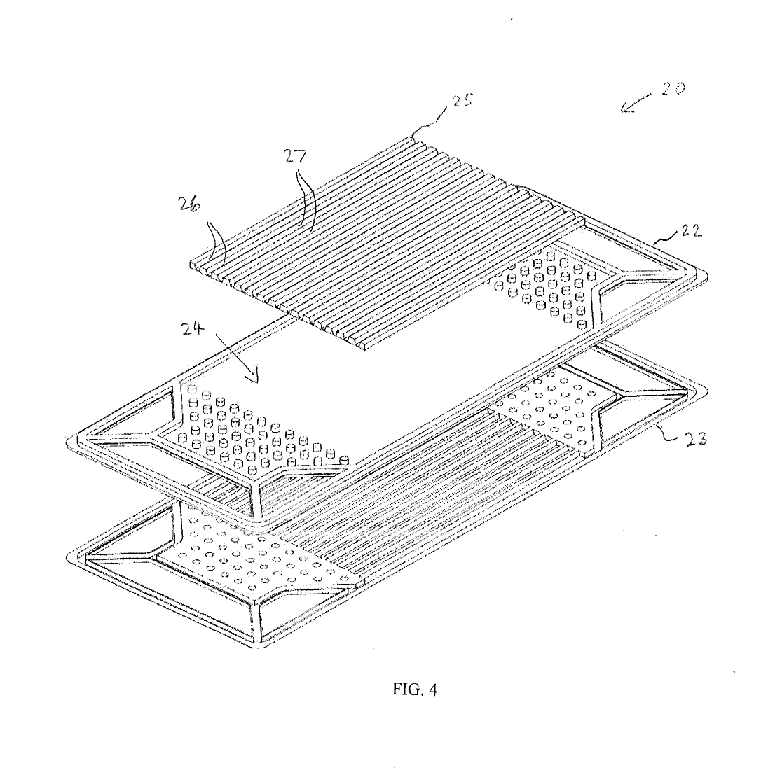

As exemplified in FIGS. 3a, 3b, and 4, bipolar plate assemblies of the invention comprise metal subassemblies comprising metal anode plates bonded to metal cathode plates and carbonaceous flow field inserts. In these Figures, the carbonaceous flow field inserts are used for the oxidant flow fields and thus are inserted into recesses in the cathode plates. For more certain electrical and thermal conductivity, the carbonaceous flow field insert can be glued into the recess with suitable electrically conductive adhesive. Alternatively, and if the contact resistances are acceptable, the insert may be fixed by simple mechanical means (e.g. a “snap-in” feature).

FIGS. 3a and 3b show schematic cross sectional views of an exploded and an assembled hybrid bipolar plate assembly 20 taken perpendicular to and through the flow fields in a like manner to

FIGS. 2a and 2b. Hybrid bipolar plate assembly 20 comprises subassembly 21 which in turn comprises metal cathode plate 22 and metal anode plate 23. Cathode plate 22 has a recess 24 into which is inserted carbon oxidant flow field insert 25. Once assembled, hybrid bipolar plate assembly 20 comprises oxidant flow field channels 26 separated by landings 27, fuel flow field channels 28, and coolant flow field channels 29.

Again, the views in FIGS. 3a and 3b are not to scale, but they qualitatively depict the dimensional advantages of the embodiment. The overall thickness of hybrid bipolar plate assembly 20 is dictated by the thickness of metal plate subassembly 21 which is desirably similar to that of embodiment 1a in FIG. 2a. And, landing radii 30 at landings 27 separating oxidant flow field channels 26 in carbonaceous flow field insert 25 are as desirably small as those of embodiment 1b in FIG. 2b. Further, draft angles 31 for oxidant flow field channels 26 in carbonaceous flow field insert 25 are as desirably small as those of embodiment 1b in FIG. 2b. Also advantageously, the hydraulic diameter of coolant flow field channels 29 can desirably be as small as those of embodiment 1b in FIG. 2b for purposes of coolant flow sharing. Further still, cathode and anode flow field plates 22, 23 can be welded together at interfaces 32 where fuel flow field channels 28 contact cathode flow field plate 22. However, there is no requirement for more difficult channel-to-channel alignment between the plates (since there are no channel-to-channel interfaces in this embodiment) thereby making the alignment process easier. Additionally, such welding does not involve welding in oxidant flow field channels and thus welding does not impose a minimum oxidant flow field channel width.

FIG. 4 shows an isometric exploded view of hybrid bipolar plate assembly 20. Identified in FIG. 4 are metal cathode plate 22, metal anode plate 23, recess 24, carbon oxidant flow field insert 25, and oxidant flow field channels 26 separated by landings 27.

The embodiments in FIGS. 3a, 3b, and 4 offer the advantages of the prior art embodiments of FIGS. 2a and 2b without many of the drawbacks. They can be manufactured by combining known methods used in the prior art to make metal and carbonaceous bipolar plate assemblies. That is, generally a metal anode plate and a metal cathode plate are formed such that a flow field is formed in the metal of one of the plates and a recess for a flow field insert is formed in the other plate. These plates are then bonded together, typically by welding, to create a metal subassembly comprising coolant channels therebetween. A carbonaceous flow field insert is formed such that reactant flow field channels separated by landings are formed in the insert. And this insert is then located into the recess. In accordance with the invention, during the forming operations, the hydraulic diameter of the coolant channels is made sufficiently small to provide for superior coolant flow sharing. And the radius of the landings and the draft angle of the reactant flow field channels are made sufficiently small to provide for superior reactant diffusion under the landings and thus obtain superior fuel cell performance.

The following examples are illustrative of the invention but should not be construed as limiting in any way.

### EXAMPLES

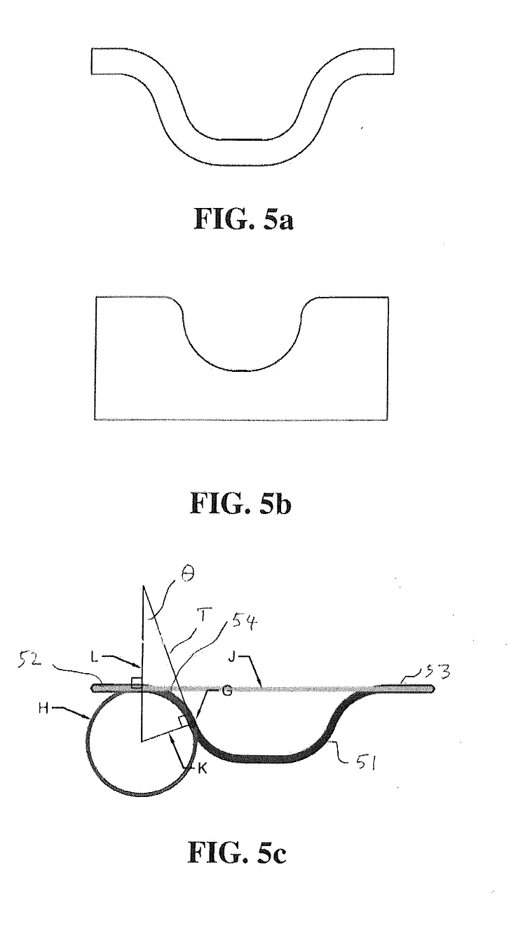

In these Examples and this specification, landing radius and draft angle were, and are intended to be, determined empirically as follows. A Carl Zeiss Surfcom 1900 SDZ Contour and Surface measurement machine is used to scan (profile) the relevant channel. FIG. 5c shows a cross-sectional profile of representative channel 51 with adjacent landings 52, 53. To determine these values, Carl Zeiss Contour Measure version 14.04 is used to analyze the scan and best fit circle H is drawn through the rounded landing corner 54. The radius K of circle H is the “landing radius”. A best fit line J is also drawn through the adjacent surfaces of landings 52, 53. Line L originates at the centre of circle H, is perpendicular to best fit line J, and serves as a reference line. Circle H overlaps rounded landing corner 54 over what is known as the landing radius arc. Point G represents the end of the landing radius arc. Line T is the tangent line to circle H at point G, and the angle θ it forms with reference line L is the “draft angle”.

### Illustrative Example Showing Effect of Oxidant Channel Features

Several solid polymer electrolyte fuel cell stacks of conventional construction for automotive use were made, in some cases with metal bipolar plate assemblies (as depicted schematically in FIG. 2a), and in other cases with carbonaceous bipolar plate assemblies (as depicted schematically in FIG. 2b). With the possible exception of the oxidant flow field channel shapes (particularly landing radii and draft angles), the dimensions of the oxidant flow fields and other dimensions in the two different assemblies were similar enough (but not identical) that no significant difference in performance was expected between the two assemblies. Yet in certain tests at current densities of 1.7 and 2.4 A/cm², the cell stacks with carbonaceous bipolar plate assemblies provided average output cell voltages about 50 and 100 mV higher respectively than the cell stacks with metal bipolar plate assemblies. This represented a significant performance difference.

To investigate the effect of landing radius and draft angle differences in the oxidant flow field channels, CFD (computational fluid dynamics) simulations were performed on oxidant flow field plates having the channel shapes depicted in FIGS. 5a and 5b. These figures show cross sectional profiles of the typical oxidant channels found in metal and carbon/plastic composite plates respectively. While both have the same hydraulic diameter, the oxidant channel landing radius in the metal oxidant flow field plate of FIG. 5a is 0.25 mm and the draft angle is 20°. The oxidant channel landing radius in the carbonaceous oxidant flow field plate of FIG. 5b is 0.08 mm and the draft angle is 4°. In CFD simulations with the same oxidant supply provided to each, it was found that the shape in FIG. 5b provided for substantially better oxidant flow velocity, oxygen concentration, and diffusion flux in the vicinity of the landing edges and in the GDL adjacent the landings. Without being bound by theory, it is believed that the performance difference between cell stacks with metal and carbonaceous bipolar plate assemblies arises from oxidant mass transport differences in the GDLs under the adjacent landings. And in turn, these differences are believed to result from differences in the oxidant channel shapes.

It is believed that practically speaking, the lower limits for forming landing radii and draft angle in metal plates are about 0.2 mm and 15° respectively. Thus, it does not seem practical with metal plates to match the values obtained in the carbonaceous plates of this example.

### Predicted Example

A hybrid bipolar plate assembly can be made as depicted in FIGS. 3a, 3b, and 4 with a metal subassembly stamped from two 0.1 mm thick 316 alloy stainless steel sheets so as to have an overall subassembly thickness of 0.9 mm. The coolant channels between the anode and cathode plates can have a hydraulic diameter of about 0.4 mm. The fuel flow field can be made to have the same dimensions as that of the metal bipolar plate assembly of the Illustrative Example above. The recess in the subassembly for the insert can be 0.41 mm deep.

The carbonaceous oxidant flow field insert can be molded from carbon/polymer composite to be 0.46 mm thick. The molded oxidant flow field can comprise channels of maximum depth about 0.3 mm, hydraulic diameter about 0.4 mm, and draft angle for the channel walls of 4°. The oxidant channels can have a width about 0.7 mm and bottom radius of 0.2 mm and be separated by landings about 0.2 mm wide with landing radii of 0.08 mm.

A hybrid bipolar plate assembly can thus be made with the same overall thickness of 0.9 mm as that of the metal bipolar plate assembly of the Illustrative Example above in combination with an oxidant flow field having similar dimensions and profile to that of the carbonaceous bipolar plate assembly of the Illustrative Example above. And therefore it is expected that the hybrid bipolar plate assembly will enjoy the smaller size of a metal bipolar plate assembly in combination with the superior performance of a carbonaceous bipolar plate assembly. Further, the coolant channels are small enough for desired coolant flow sharing.

All of the above U.S. patents, U.S. patent application publications, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. For instance, while the preceding description was primary directed at embodiments comprising carbonaceous oxidant flow field inserts, it may be desirable for other reasons to consider embodiments comprising carbonaceous fuel flow field inserts. Such modifications are to be considered within the purview and scope of the claims appended hereto.

What is claimed is:

1. A hybrid bipolar plate assembly for a fuel cell comprising:
a metal subassembly comprising a metal anode plate bonded to a metal cathode plate wherein
the metal subassembly comprises coolant channels between the anode and cathode plates, one of the plates comprises a flow field formed in the metal, and the other plate comprises a recess for a flow field insert; and
a carbonaceous flow field insert located in the recess wherein the insert comprises reactant flow field channels separated by landings.

2. The hybrid bipolar plate assembly of claim 1 wherein the metal anode plate is welded to the metal cathode plate.

3. The hybrid bipolar plate assembly of claim 1 wherein the anode plate comprises a fuel flow field formed in the metal, the cathode plate comprises a recess for an oxidant flow field insert, and the carbonaceous flow field insert is a carbonaceous oxidant flow field insert.

4. The hybrid bipolar plate assembly of claim 3 wherein the carbonaceous oxidant flow field insert comprises a carbon/plastic composite.

5. The hybrid bipolar plate assembly of claim 4 wherein the carbonaceous oxidant flow field insert is molded.

6. The hybrid bipolar plate assembly of claim 3 wherein the hydraulic diameter of the coolant channels is less than or about 0.5 mm.

7. The hybrid bipolar plate assembly of claim 3 wherein the carbonaceous oxidant flow field insert comprises a plurality of parallel straight oxidant flow field channels separated by landings.

8. The hybrid bipolar plate assembly of claim 7 wherein the radius of the landings is less than or about 0.1 mm.

9. The hybrid bipolar plate assembly of claim 7 wherein the draft angle of the oxidant flow field channels is less than or about 10 degrees.

10. The hybrid bipolar plate assembly of claim 7 wherein the width of the oxidant flow field channels is less than about 0.9 mm.

11. The hybrid bipolar plate assembly of claim 7 wherein the carbonaceous oxidant flow field insert is less than about 0.5 mm thick.

12. The hybrid bipolar plate assembly of claim 7 wherein the hybrid bipolar plate assembly is less than or about 1.1 mm thick.

13. A fuel cell comprising the hybrid bipolar plate assembly of claim 1.

14. The fuel cell of claim 13 wherein the fuel cell is a solid polymer electrolyte fuel cell.

15. A method of manufacturing the hybrid bipolar plate assembly of claim 1 comprising:
forming a metal anode plate and a metal cathode plate such that a flow field is formed in the metal of one of the plates and a recess for a flow field insert is formed in the other plate;
bonding the metal anode plate and the metal cathode plate together to create a metal subassembly comprising coolant channels between the anode and cathode plates;
forming a carbonaceous flow field insert such that reactant flow field channels separated by landings are formed in the insert; and
locating the carbonaceous flow field insert into the recess.

16. The method of claim 15 wherein the hydraulic diameter of the coolant channels is less than or about 0.5 mm.

17. The method of claim 15 wherein the radius of the landings is less than or about 0.1

18. The method of claim 15 wherein the draft angle of the reactant flow field channels is less than or about 10 degrees.

19. A method of manufacturing a thin bipolar plate assembly for a fuel cell comprising:
forming a metal anode plate and a metal cathode plate such that a flow field is formed in the metal of one of the plates and a recess for a flow field insert is formed in the other plate;
bonding the metal anode plate and the metal cathode plate together to create a metal subassembly comprising coolant channels between the anode and cathode plates wherein the hydraulic diameter of the coolant channels is sufficiently small to provide for superior coolant flow sharing;
forming a carbonaceous flow field insert such that reactant flow field channels separated by landings are formed in the insert wherein the radius of the landings and the draft angle of the reactant flow field channels are sufficiently small to provide for superior reactant diffusion under the landings; and
locating the carbonaceous flow field insert into the recess.
